(19) United States
(12) Patent Application Publication
(10) Pub. No.: US 2003/0236802 A1
(43) Pub. Date: Dec. 25, 2003

(54) Method and apparatus for generating a random number using the meta-stable behavior of latches

(75) Inventor: Michael A. Epstein, Spring Valley, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/176,210

(22) Filed: Jun. 20, 2002

(51) Int. Cl. G06F 1/02

(52) U.S. Cl. 708/250

(57) ABSTRACT

A method and apparatus are disclosed for generating random numbers using the meta-stable behavior of latches. Each time a latch becomes meta-stable, the outcome of the oscillation is random as to the logic value attained after the oscillation ceases. If the output of a latch differs from the value that would have been attained during correct operation of the latch (i.e., a “mistake”), then a meta-stable event can be detected. When two or more substantially identical latches operate in parallel, a mistake can be detected when at least two of the latches have different outputs. The detection of a mistake can be used to trigger the generation of a random bit. The present invention operates a number of latches in parallel, and applies the same binary value to each input of each latch. When a latch enters a meta-stable state, the output of the latch will shift randomly before stabilizing at a random output value of either logic low or high. When two latches stabilize to different values, a mistake can be identified thereby triggering the generation of a random bit.

### CROSS-REFERENCE TO RELATED APPLICATIONS

The present invention is related to U.S. patent application Ser. No. 09/519,549, filed Mar. 6, 2000, entitled “Method and Apparatus for Generating Random Numbers Using Flip-Flop Meta-Stability,” and U.S. patent application Ser. No 09/912,685, filed Jul. 25, 2001, entitled “Method and Apparatus for Decorrelating a Random Number Generator Using a Pseudo-Random Sequence,” each assigned to the assignee of the present invention and incorporated by reference herein.

### FIELD OF THE INVENTION

The present invention relates to random number generation, and more particularly, to a method and apparatus for generating random numbers using the meta-stable behavior of latches.

### BACKGROUND OF THE INVENTION

Latches and flip-flops are widely used in computers and other electronic devices, for example, as sampling, counting and storage elements. A conventional R-S latch 100 is shown in FIG. 1. As in FIG. 1, the R-S latch 100 is comprised of two NOR gates 110 and 120. The outputs of the two NOR gates 110, 120 are cross-connected to a respective input of the opposite NOR gate. Thus, NOR gate 110 receives the output of NOR gate 120 and a reset signal, R, as inputs. Likewise, NOR gate 120 receives the output of NOR gate 110 and the set signal, S, as inputs. The output of the R-S latch 100 for each of the various input combinations is shown in the table 200 in FIG. 2.

Thus, the latches 100 shown in FIG. 1 are susceptible to meta-stability when both inputs to the latch 100 are set at a high logic value (“11”) and then transition to a state where both inputs are at a low value (“00”). This transition occasionally causes the latch outputs to oscillate unpredictably in a statistically known manner. For a detailed discussion of meta-stability, see, for example, Application Note, A Meta-Stability Primer, AN219, Philips Semiconductors (Nov. 15, 1989), incorporated by reference herein. In theory, the latch 100 can oscillate indefinitely. In practice, however, the latch 100 will randomly arrive at a random output value of either logic low or high. Typically, these meta-stable values are subsequently detected by other circuitry in a given application and can be interpreted as different logic level states or assume an intermediate state that can be misinterpreted by other logic gates.

Many applications and electronic devices require random numbers, including games of chance, such as poker, roulette, and slot machines. In particular, numerous cryptographic algorithms and protocols depend on a non-predictable source of random numbers to implement secure electronic communications and the like. A random number generator should generate every possible permutation in the designated range of numbers. In addition, the random number generator should not be biased and should generate any given number with the same probability as any other number. Moreover, the random number generator should generate random numbers that cannot be predicted, irrespective of the size of the collection of previous results. Thus, the random numbers should be completely unpredictable and non-susceptible to outside influences.

U.S. patent application Ser. No. 09/519,549, filed Mar. 6, 2000, entitled “Method and Apparatus for Generating Random Numbers Using Flip-Flop Meta-Stability,” discloses a method and apparatus for generating random numbers using the meta-stable behavior of flip-flops. A flip-flop is clocked with an input that deliberately violates the setup or hold times (or both) of the flip-flop to ensure meta-stable behavior. A bit is collected whenever there is an error. If meta-stability occurs more frequently with one binary value (either zero or one) for a given class of flip-flops, an even random number distribution is obtained by “marking” half of the zeroes as “ones” and the other half of the zeroes as “zeroes.” In addition, half of the ones are marked as “ones” and the other half are marked as “zeroes”.

It has been found that the duration and occurrence of meta-stability can be affected by noise. Thus, noise can be employed to influence the output of the random number generator. U.S. patent application Ser. No. 09/912,685, filed Jul. 25, 2001, entitled “Method and Apparatus for Decorrelating a Random Number Generator Using a Pseudo-Random Sequence,” discloses a random number generator based on meta-stability that employs a linear feedback shift register (LFSR) to decrease the chance of correlation and reduce any bias in the output.

While such random number generators based on the meta-stable behavior of flip-flops provide an effective mechanism for generating random numbers using only digital technology, they each employ a single flip-flop and thus must presume an understanding of what the output was supposed to be. It would be desirable to have a random number generator that uses only digital technology but does not require any presumptions about the output.

### SUMMARY OF THE INVENTION

Generally, a method and apparatus are disclosed for generating random numbers using the meta-stable behavior of latches. Each time a latch becomes meta-stable, the outcome of the oscillation is random as to the outcome or logic value attained after the oscillation ceases. If the output of a latch differs from the value that would have been attained during correct operation of the latch (i.e., a “mistake”), then a meta-stable event can be detected. When two or more substantially identical latches operate in parallel, a mistake can be detected when at least two of the latches have different outputs. The detection of a mistake can be used to trigger the generation of a random bit in accordance with the present invention.

As previously indicated, a latch is susceptible to meta-stability when both inputs to the latch are set at a high logic value (“11”) and then transition to a state where both inputs are at a low value (“00”). The present invention operates a number of latches in parallel, and applies the same binary value to each input of each latch. Thus, when a value of “00” is applied to each latch, the latches will be expected to maintain their previous state. When a value of “11” is followed by a state where both inputs are at a low value (“00”) for each latch, however, the state of the latches may be indeterminate, causing a random shift before stabilizing at a random output value of either logic low or high. Thus, when two latches stabilize to different values, a mistake can be identified thereby triggering the generation of a random bit in accordance with the present invention.

A more complete understanding of the present invention, as well as further features and advantages of the present invention, will be obtained by reference to the following detailed description and drawings.

### BRIEF DESCRIPTION OF THE DRAWING

FIG. 1 illustrates a conventional R-S latch;

FIG. 2 is a table indicating the various output values of the R-S latch of FIG. 1 for each input combination;

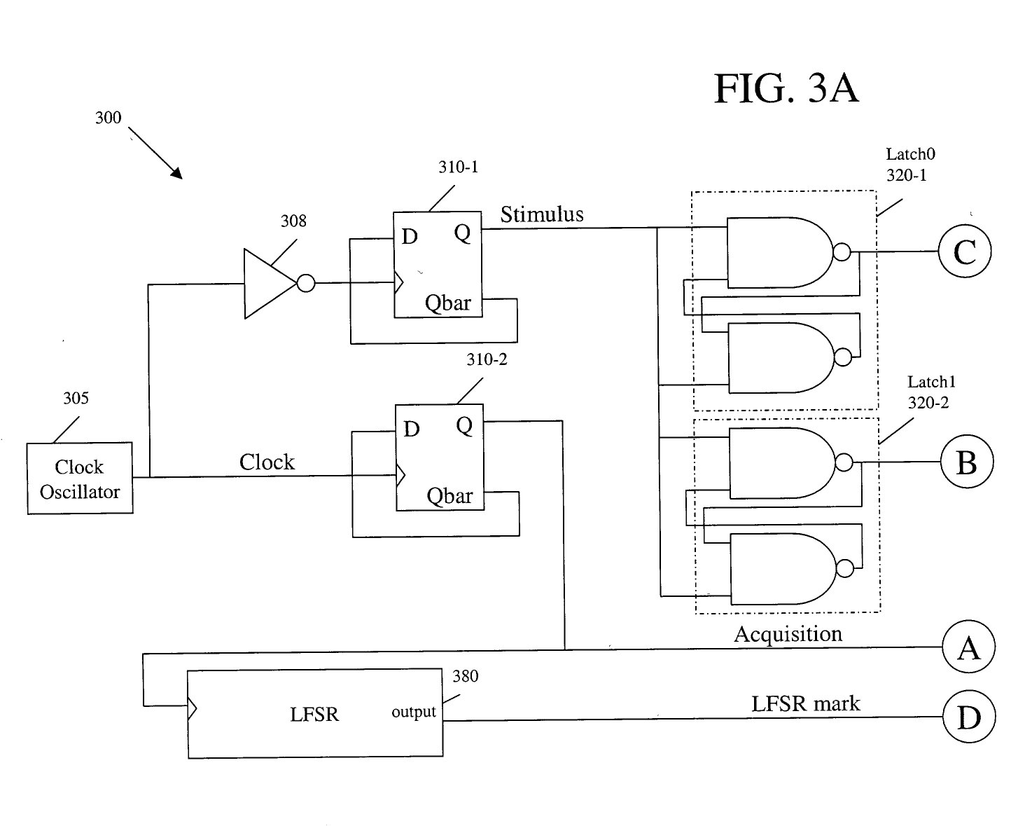

FIGS. 3A and 3B, collectively, illustrate a random number generator in accordance with the present invention;

FIG. 4 illustrates a set of waveforms produced by the circuits of FIGS. 3A and 3B; and

FIG. 5 illustrates a selection circuit that may be employed in one embodiment of the present invention to detect a meta-stable event when a plurality of latches is employed.

### DETAILED DESCRIPTION

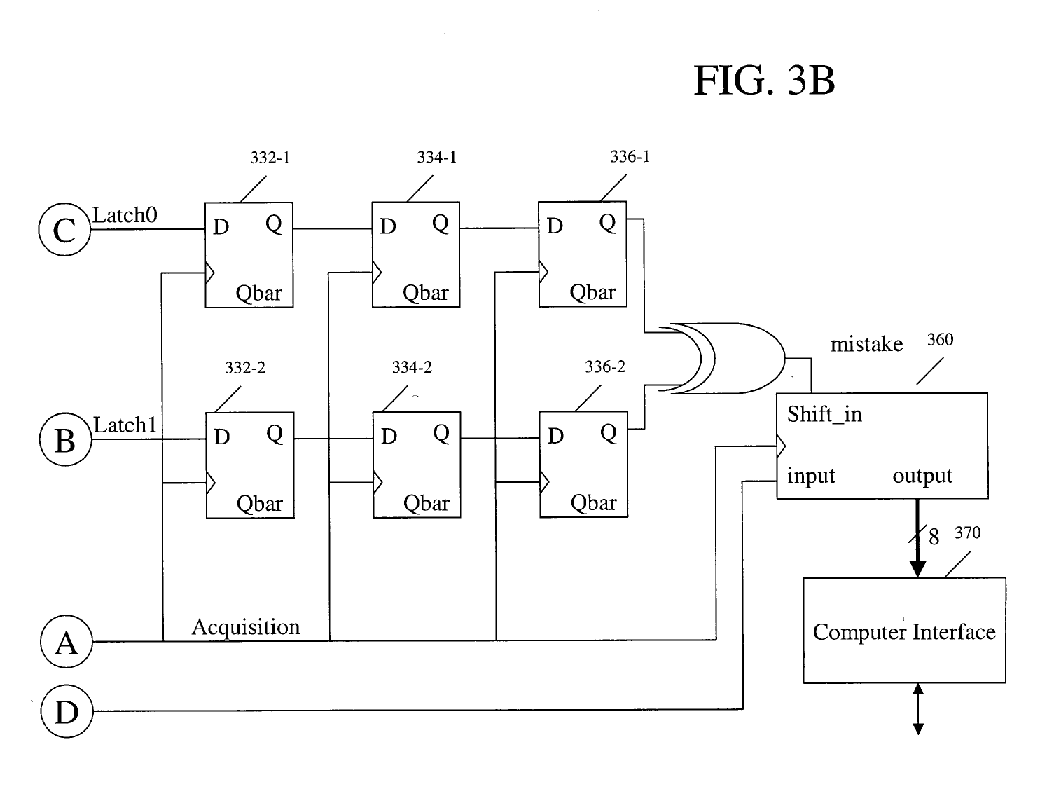

FIGS. 3A and 3B, collectively, illustrate a random number generator 300 in accordance with the present invention. As shown in FIG. 3, the exemplary random number generator 300 includes a pair of latches 320-1, 320-2, that are driven into the meta-stable region. As discussed more fully below, the output of the latches 320-1, 320-2 are captured by a circuit that removes the meta-stability and compares the output. When the two outputs of the substantially identical latch circuits are different, a “mistake” is detected and a random bit is generated. Thus, the meta-stable operation of either of the latches 320-1, 320-2 provides a mechanism for generating random numbers.

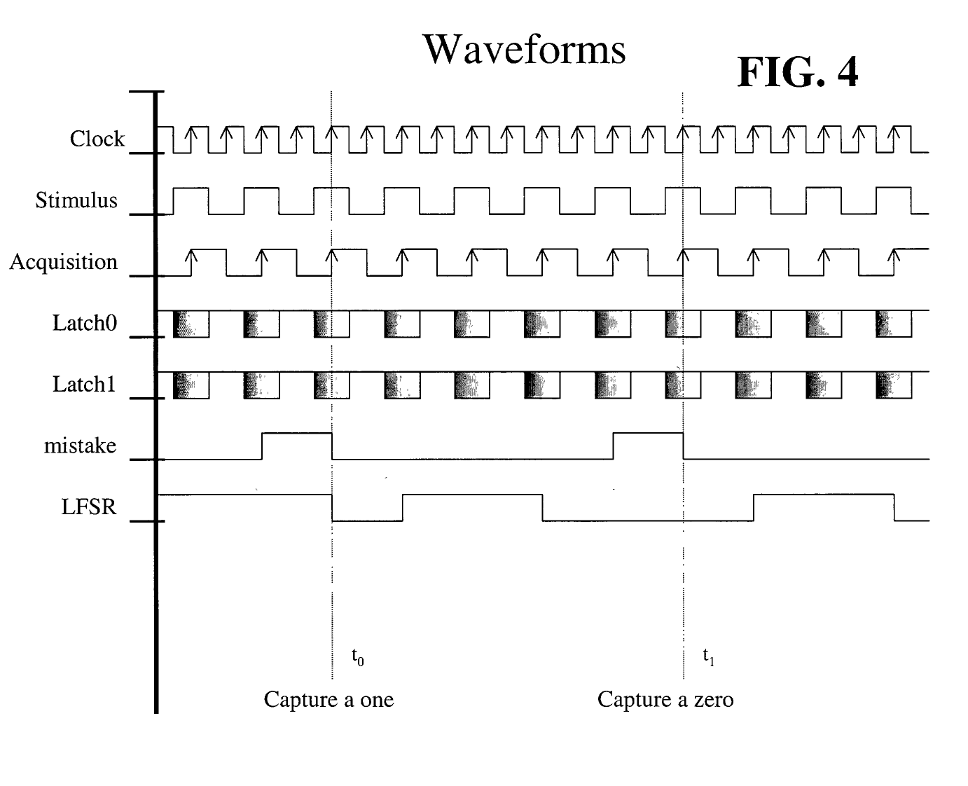

As shown in FIG. 3A, a “Clock” signal is generated by a clock oscillator 305. The Clock signal is applied to the inputs of a pair of D-type flip-flops 310-1, 310-2 whose Qbar outputs are fed back into their D inputs. The D-type flip-flops 310 provide a divide-by-two mechanism. The clock input of the flip-flop 310-1 is inverted by an inverter 308. Thus, the Stimulus signal generated by the flip-flop 310-1 is 180 degrees out of phase with the Acquisition signal generated by the flip-flop 310-2. The Acquisition signal advances and LFSR 380 generates a bit stream that statistically is half ones and half zeros. It is noted that the various waveforms shown in FIG. 4 are obtained at the corresponding labeled sample points in FIG. 3A or 3B.

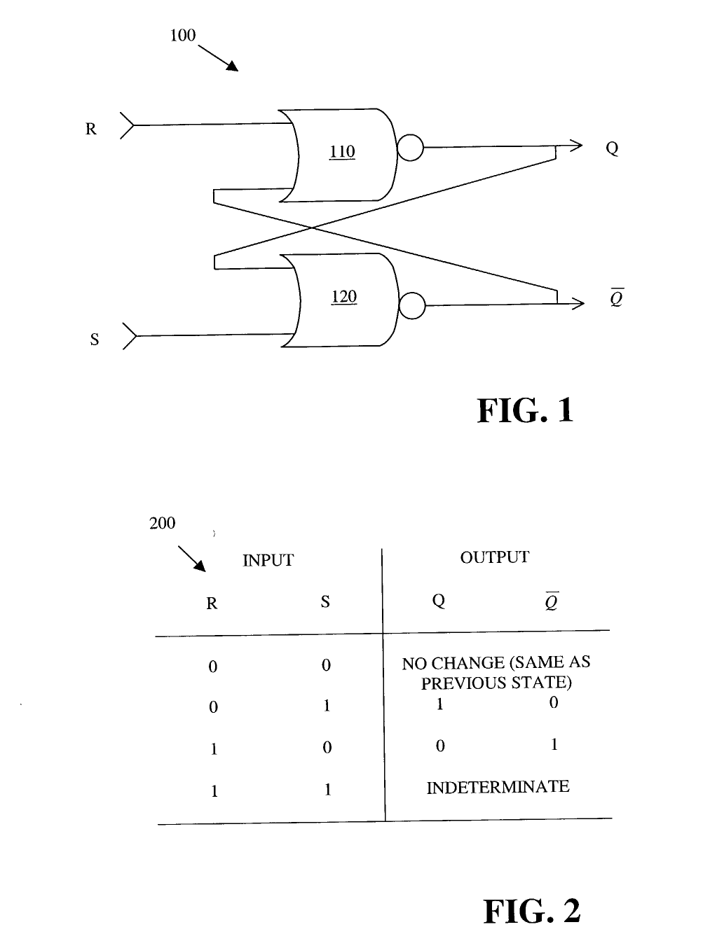

As shown in FIGS. 3A and 4, the latches 320-1 and 320-2 are driven by the Stimulus signal generated by the flip-flop 310-1. As previously indicated, latches, such as the latches 320-1 and 320-2 shown in FIG. 3A, are susceptible to meta-stability when both inputs to the latch 310 are set at a low logic value (“00”) and then transition to a state where both inputs are at a high value (“11”). It is noted that the latches 320-1 and 320-2 in FIG. 3A are comprised of NAND gates and work differently than the NOR gate latch 100 of FIG. 1. Thus, as shown in FIG. 4, the output of the latches 320-1 and 320-2, labeled “Latch0” and Latch1″ in FIG. 3A, respectively, are potentially indeterminate each time the Stimulus signal is high. While the output of one of the NAND gates in each latch 320-1 and 320-2 is designated as the output of the latch 320-1 and 320-2, the output of either NAND gate can be selected (since they are substantially identical), as would be apparent to a person of ordinary skill in the art. As a result of the non-uniform delay in each of the latches 320 and as a result of the non-uniform delay from the meta-stable behavior a potentially indeterminate signal may be generated. Thus, to make the random number generator 300 suitable for synchronous applications, an illustrative mechanism is provided in FIG. 3B to synchronize the waveforms LatchO and Latchl with one another. It is noted that the circuitry of FIGS. 3A and 3B are connected by joining the bubbles of like letters.

The synchronizing circuitry shown in FIG. 3B includes a number of serial flip-flops 332-n, 334-n and 336-n associated with each latch 320. The serial flip-flops 332, 334 and 336 are selected so as to not enter a meta-stable state easily. In addition, if one of these flip-flops 332, 334, 336 does become meta-stable, the period of the clock signal should be long enough so that the output of the meta-stable flip-flop will settle to a fixed logic value (either 0 or 1), such that when the signal is sampled at the next flip-flop 332, 334, 336, the flip-flop is stable. In this manner, each flip-flop 332, 334, 336 improves the chance of synchronizing the output Latch0 or Latch1 with the one another, while removing any indeterminate logic state. Indeed, the chances of incorrect behavior for such a circuit will be measured in tens of years.

The exclusive or gate (“XOR”) 350 compares the synchronized version of the waveforms Latch0 and Latch1. Since the output of the XOR gate 350 will be high if and only if the two inputs differ, the output of the XOR gate 350 (“Mistake”) will be high if the waveform Latch0 does not match the waveform Latch1. The Mistake may arise from: (i) one latch 320 becoming meta-stable and the other latch 320 remaining stable; (ii) both latches 320 becoming meta-stable but arriving at different end states; or (iii) driving the flip-flops 332, 334, 336 into the meta-stable state. In any case, a Mistake should be a relatively rare event, dependent upon, e.g., the implementation technology and circuit layout. It is noted that in an alternate embodiment, a Mistake can be defined as the waveforms Latch0 and Latch1 matching one another.

The output of the XOR gate 350 (“Mistake”) is applied to the shift input (Shift_in) of a shift register 360, and the shift register 360 will shift a bit over from the LFSR signal (discussed below) every time there is a Mistake. The shift register 360 is clocked by the Acquisition signal. Thus, the first embodiment of the present invention collects a bit whenever there is an error (mistake). The output of the shift register 360 is applied to a computer interface 370.

As shown in FIG. 4, a mistake is detected at time t₀ by the XOR gate 350, causing a bit equal to one (based on the LFSR signal) to be acquired. Similarly, a mistake is detected at time t₁ by the XOR gate 350, causing a bit equal to zero (based on the LFSR signal) to be acquired.

As previously indicated, marking input bits in the manner discussed above in conjunction with FIGS. 3A and 3b to generate the Acquisition signal provides an even distribution of random output bits. It has been found, however, that the duration and occurrence of meta-stability can be affected by noise. Thus, if the noise is correlated to the Acquisition signal, then the output of the random number generator will not be random.

Therefore, according to one embodiment of the invention, a nearly unbiased (with regards to frequency of zeroes and ones) signal source is used as the marking signal. The marking signal is uncorrelated with a high probability to any noise in the system. The present invention optionally employs a linear feedback shift register (LFSR) 380 with sufficient length to decrease the chance of correlation and reduce any bias in the LFSR output. Suitable LFSRs are described, for example, in Bruce Schneier, Applied Cryptography, pages 369-388 (Wiley, 1994). For a more detailed discussion of the operation of linear feedback shift registers in random number generators, see U.S. patent application Ser. No. 09/912,685, filed Jul. 25, 2001, entitled “Method and Apparatus for Decorrelating a Random Number Generator Using a Pseudo-Random Sequence,” incorporated by reference herein.

The linear feedback shift register 380 generates an LFSR Mark signal, shown in FIG. 4, that creates slightly more than half of its output as zeroes in the waveform. In this manner, the LFSR mark signal is uncorrelated to a high probability to any noise.

The linear feedback shift register 380 should provide a sufficient number of bits to decrease the chance of correlation and reduce any bias in the LFSR output. For a linear feedback shift register 380 comprised of n flip-flops, there will be 2ⁿ−1 binary numbers before the numbers begin to repeat. Thus, as the number of flip-flops in the linear feedback shift register 380 increases, the −1 in the 2ⁿ−1 binary expression becomes less significant. In any event, since the direction of any bias attributable to the −1 term is known, the bias can be removed or corrected with a suitable circuit.

Thus, the linear feedback shift register 380 provides a marking output, LFSR mark, that is pseudo-random, with approximately half of the output bits being a zero and the other half of the output bits being a one.

It has been observed that if the linear feedback shift register 380 is insecure, a portion of the output (even a random portion) may allow the state of the linear feedback shift register 380 to be known. In this manner, it would be possible to predict the output of the random number generator 300. Thus, a linear feedback shift register 380 should be utilized that has no discernable statistics, thereby making the state information of the linear feedback shift register 380 useless. In a further variation, additional security is achieved by releasing the collected bits out of the shift register 360 and by allowing some of the collected bits to be lost in each collection interval.

The shift register 360 shifts a bit over from the LFSR mark signal every time there is a Mistake. In this manner, the arrival times of the mistakes are not discerned, and someone cannot predict which bits of the linear feedback shift register 380 will be chosen.

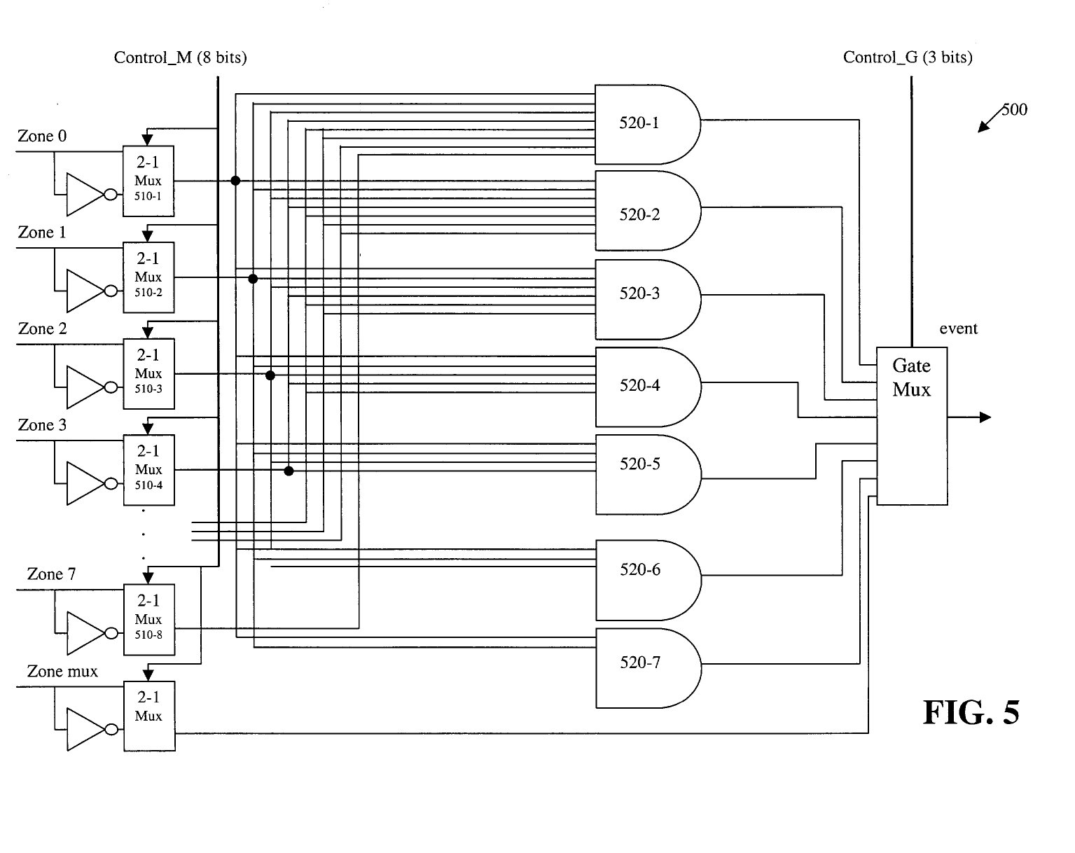

FIG. 5 illustrates an alternate embodiment of the present invention. FIG. 5 illustrates selection circuitry 500 for determining when an “event” (e.g., a mistake) has occurred when there are at least three (3) latches. The exemplary selection circuitry 500 is implemented using AND gates. The output of each of the n latches are received at the input of the selection circuitry 500, and are labeled Zone n. In the exemplary embodiment, n is equal to eight (8). The respective zone inputs and an inverted version thereof are each applied to a corresponding multiplexer 510-n. Each multiplexer 510 is controlled by a control signal, Control_M, that selects the zone input or corresponding inverted version thereof.

The selection circuitry 500 includes an array of AND gates 520-1 through 520-n−1, where each of the n AND gates receives between 2 and n inputs, as shown in FIG. 5. Each AND gate 520 will generate a binary value of one (1) if the applied input pattern is useful. For example, the AND gate 520-n−1 will generate a one (1) only when both inputs (from zone 0 and zone 1) are high (an expected condition for substantially identical latches).

By selecting the inverted input at Zone 0 and the uninverted input at Zone 1, however (or vice versa), with appropriate selection of the Control_M signal, the AND gate 520n−1 will generate a one (1) every time Zone 0 has a value of one and Zone 1 has a value of zero (i.e., they are different, which is a less likely condition for substantially identical latches). It is again noted that since the latches (not shown in FIG. 5) are substantially symmetric, it is equally likely that an uninverted output could be arbitrarily designated as the output of a given latch. Thus, the multiplexers 510 allow the correct configuration to be selected, where the latches will disagree only under meta-stable conditions. For example, various combinations can be evaluated, until a combination is identified that exhibits meta-stable behavior only occasionally (since a combination that always or never exhibited meta-stable behavior would be undesirable).

The AND gate 520-n−1 will not generate a one (1), however, if Zone 0 has a value of zero and Zone 1 has a value of one (leading to some loss of efficiency relative to an XOR implementation). Similarly, the AND gate 520-n−1 will not generate a one (1) if Zone 0 and Zone 1 both have a value of zero or one (they agree). The exemplary selection circuitry 500 allows up to eight (8) latches to be combined in various ways to create an “event” that triggers the generation of a random bit.

It is to be understood that the embodiments and variations shown and described herein are merely illustrative of the principles of this invention and that various modifications may be implemented by those skilled in the art without departing from the scope and spirit of the invention.

What is claimed is:

1. A method for generating a random number using a latch, comprising the steps of:
detecting a meta-stable state of said latch; and
generating a random bit based upon an occurrence of said meta-stable state.

2. The method of claim 1, wherein said detecting step further comprises the step of operating a plurality of latches in parallel and detecting a different output at two or more of said latches.

3. The method of claim 2, wherein said step of detecting a different output at two or more of said latches is performed using an exclusive OR (XOR) gate.

4. The method of claim 1, further comprising the step of decorrelating a marking signal to noise.

5. The method of claim 4, wherein said decorrelating step is performed by at least one linear feedback shift register.

6. The method of claim 1, wherein said generating step further comprises the step of generating a mistake signal if an output of a first latch does not match an output of a second latch.

7. The method of claim 6, wherein the mistake signal causes a random bit to be acquired based on the marking input.

8. The method of claim 1, further comprising the step of synchronizing an output of said latch with a local clock source.

9. The method of claim 1, further comprising the step of collecting a plurality of said random bits to produce a random number.

10. The method of claim 1, further comprising the step of releasing collected bits from a shift register to generate said random bit.

11. The method of claim 1, wherein said detecting step further comprises the step of comparing the outputs of a plurality of latches in a collection of predefined outputs and generating a random bit if one of said collection of predefined outputs is detected.

12. The method of claim 1, wherein said detecting step further comprises the step of operating a plurality of latches in parallel and wherein said method further comprises the step of evaluating a plurality of combinations of selecting and combining inverted and uninverted outputs of said plurality of latches to find a suitable combination.

13. A random number generator, comprising:
a latch operated in a meta-stable state to generate a random bit based upon an occurrence of said meta-stable state.

14. The random number generator of claim 13, wherein said occurrence of said meta-stable state is detected by operating a plurality of latches in parallel and detecting a different output at two or more of said latches.

15. The random number generator of claim 13, wherein an output of said latch is synchronized with a local clock source.

16. The random number generator of claim 13, wherein a plurality of said random bits are collected to produce a random number.

17. The random number generator of claim 13, wherein collected bits from a shift register are released to generate said random bit.

18. The random number generator of claim 13, wherein said occurrence of said meta-stable state is detected by comparing outputs in a collection of predefined outputs and generating a random bit if one of said collections of predefined outputs is detected.

19. A random number generator, comprising:
a plurality of latches operated in parallel, such that at least two of said latches generate different outputs to generate a random bit.

20. The random number generator of claim 19, further comprising an exclusive OR (XOR) gate to detect a different output by said at least two of said latches.

21. The random number generator of claim 19, wherein a plurality of said random bits are collected to produce a random number.
